(19) United States
(12) Patent Application Publication
(10) Pub. No.: US 2002/0156870 A1
(43) Pub. Date: Oct. 24, 2002

(54) Method and apparatus for dynamically directing an application to a pre-defined target multimedia resource

(75) Inventors: Behzad Boroumand, Belmont, CA (US); Julian J. Bunn, Pasadena, CA (US); Jaysen S. Gillespie, Irvine, CA (US); Martin S.L. Retana, Glendale, CA (US); Michael Rizzo JR., Burbank, CA (US)

Correspondence Address: Dinh & Associates, Truong Dinh, 2506 Ash Street, Palo Alto, CA, 94306, US

(73) Assignee: Equate Systems, Inc., Irvine, CA (US)

(21) Appl. No.: 10/008,597

(22) Filed: Nov. 8, 2001

Related U.S. Application Data
(60) Provisional application No. 60/246,875, filed on Nov. 8, 2000.
(60) Provisional application No. 60/325,384, filed on Sep. 26, 2001.

(51) Int. Cl. G06F 15/16

(52) U.S. Cl. 709/219; 717/171

(57) ABSTRACT

Innovative techniques for facilitating easy and convenient access to multimedia resources such as Web pages and static and streaming audio and video content based on “hotkey” technology. The significant and unique aspects described include: (1) a simple client software that is installed on an end-user's computer, (2) a method of uniquely associating each user with an anonymous identification code, (3) a server architecture that is coupled to a database of demographic user data with time-stamped key through data, (4) a suite of software modules that enable hotkey configuration, server load balancing, and database mining tools, and other features.

### BACKGROUND OF THE INVENTION

The present invention relates generally to the World Wide Web and to both local and network remote multimedia resources. In particular, the present invention relates to a novel and improved method and apparatus for dynamically directing an application such as a Web browser to a pre-defined multimedia resource, such as a URL (Uniform Resource Locator).

The World Wide Web, commonly known as the Internet, has made it possible for users to access data stored all over the world from their computers. Various applications, such as multimedia players, also provide access to content hosted on the user's computer and/or hosted on remote (network-connected) servers.

It is very common for users to access the same set of5 or 10 Web sites (e.g., Yahoo!, AOL, and so on) and to access these sites on a continual basis throughout the day (e.g., to check for news headlines, updated stock quote, and so on). Using a conventional method, a user would need to move the mouse to the Web browser icon in the system tray, click on it to activate the Web browser, click on the Favorites tab, scroll down to a desired Web site, and click once more. A total of three clicks and two movements of the mouse are needed for each Web access. These mouse clicks and movements amount to a major inconvenience if the user repeats them throughout the day.

For many sites, it is highly desirable to collect demographic information from users. This information may be used to provide enhanced service, targeted advertisements, and so on. There is currently no easy means to collect demographic information from users.

Thus, techniques that allow users to access both Web sites on the World Wide Web and local/remote multimedia resources in a quick and efficient manner are highly desirable.

The invention provides techniques for facilitating easy and convenient resource access based on “hotkey” technology. The significant and unique aspects of the invention includes: (1) a simple client software that is installed on an end-user's computer, (2) a method of uniquely associating each user with an anonymous identification code, (3) a server architecture that is coupled to a database of demographic user data with time-stamped key through data, (4) a suite of software modules that enable hotkey configuration, server load balancing, and database mining, and (5) other features described herein.

An aspect of the invention provides a method for directing a Web browser to a Uniform Resource Locator (URL). As used herein, the term Uniform Resource Locator means a fully qualified address of a file or other resource on the network. Specific examples of URLs include HTTP addresses, local file names, NFS, CIFS, and names in other distributed shared file systems. In accordance with the method, a set of keys on a user device (e.g., a computer) is initially mapped to a set of URLs. Thereafter, activation of a particular mapped key is detected and, in response, a URL associated with the activated mapped key is retrieved. The Web browser is then directed to the retrieved URL.

Another aspect of the invention relates to automatic invocation of an appropriate media player given the location or address of a multimedia resource, such as a streaming audio or video server, a local disk-resident audio or video file, or a remotely located audio or video file.

In one embodiment, a mapping is created between certain keys on the user's keyboard and the associated resources or URLs. An activated key causes the associated URL to be processed by a suitable application. The identifier for the mapped key, and the identifier of the associated URL, are configured using a software tool that presents the user with a menu of possible choices, which also includes freedom to specify a URL outside of a preset menu list. A unique identification code (UIC) is used by the system to identify the user to an arbitrarily specific level of demographic detail, which may range from superficial to highly specific, according to the configuration of the system.

In the above embodiment, each of the keyboard Function (F1-F12) keys on a standard US-101 keyboard may be mapped to a separate multimedia resource. For example, the F1 key may be mapped to a particular MP3 file locally resident on the user's system disks, the F2 key may be mapped to a streaming audio radio station on the Internet, the F3 key may be mapped to a “playlist” of local and remote multimedia files, and so on. The up and down arrow keys on the keyboard may be mapped to controls that move backwards and forwards between tracks or index points or items in the playlist. The left and right arrow keys may serve as convenient controls for audio volume.

A “desktop toolbar”, which is a software application running locally on the user's computer, can provide further functionality beyond the simple keyboard key presses. The toolbar may be used as a visual mnemonic for the settings and status of the system. The toolbar is created as a component of the complete client software that executes on the user's computer. Its appearance may be customized at the time of the installation of the client software and/or later whilst the user's computer is connected to the network. When a network connection is present and active, the toolbar component is used to display real-time information that is received from the server component of the system. If a network connection is not present, the toolbar still offers complete functionality for those multimedia resources that do not require connection to the network to be accessed. The size, shape, appearance and position of the toolbar may be fully customizable.

In another embodiment, the HTTP request generated for the activated mapped key includes the URL associated with the activated mapped key, an identifier for the activated mapped key, and a unique identification code (UIC). The associated URL can be for a Web page on a server designated to process requests generated in response to activation of any one of the mapped keys. The UIC can include demographic data for a user of the user device, and can be generated based on a pseudo-random number. The mapped keys can be enabled and disabled, for example, by toggling a toggle key.

Yet another aspect of the invention provides a method for mapping a set of keys on a user device to a set of URLs. In accordance with the method, each key in a first set of keys is initially associated with a respective set of one or more URLs. For each key in the first set, a selection for a particular URL in the associated set of URLs is received, and the key is mapped to the selected URL. Each key in a second set of one or more keys may be associated with a respective URL. Each key in a third set of one or more keys may be associated with an unrestricted URL. For each of these keys, an entry for a particular URL may be received, and the key is mapped to the entered URL. The URL for each mapped key is stored to a storage unit.

Yet another aspect of the invention provides a method for processing multimedia resource requests from the client at a first server. In accordance with the method, a request is received from a user device, with the request including a UIC and an identifier for a particular key activated to generate the request. A complete address for the multimedia resource associated with the activated key is then determined, and the received request is directed to the appropriate for the activated key. The address for the activated key can be determined based on the UIC and the identity of the activated key, both provided in the request from the client. The UIC may encapsulate demographic information for a user, and the server may further collect demographic information associated with the received request.

Various aspects, embodiments, and features of the invention are described in further detail below.

The foregoing, together with other aspects of this invention, will become more apparent when referring to the following specification, claims, and accompanying drawings.

### BRIEF DESCRIPTION OF THE DRAWINGS

FIG. 1 is a block diagram of a system that can implement various aspects of the invention;

FIG. 2 is a block diagram of a user computer and a central server in accordance with a specific embodiment of the invention;

FIG. 3 is a flow diagram of a process for mapping and utilizing “hotkeys” on the user computer;

FIG. 4 is a diagram of a hotkey setup page in accordance with an embodiment of the invention;

FIG. 5 is a flow diagram of a process for handling a key press of a hotkey in accordance with an embodiment of the invention;

FIG. 6 is a flow diagram of a process for handling an HTTP request generated in response to a hotkey press in accordance with an embodiment of the invention;

FIG. 7A is a diagram that illustrates a conventional Web site logging technique;

FIG. 7B is a diagram that illustrates a Web site logging technique in accordance with an aspect of the invention; and

FIG. 8 is a block diagram of an embodiment of a computer system that can be used to implement the user computer or the central computer in FIG. 1.

### DESCRIPTION OF THE SPECIFIC EMBODIMENTS

The invention provides techniques for dynamically directing an application to a pre-defined Uniform Resource Locator (URL) locally or on the network based on previously entered user preferences and possibly further based on demographic data. Existing physical or virtual keys or buttons on the end user's device are mapped to a customizable set of multimedia URLs, which can include World Wide Web addresses, local file names, remote file names, remote streaming multimedia ports, other network-accessed content, and so on.

For each multimedia file type, an appropriate application, as configured in the user's system, is invoked to process the multimedia content. For example, the user's Web browser is invoked for World Wide Web addresses, the user's MP3 player is invoked. for MP3 files, and so on. These file associations may be controlled and configured by the user using the operating system. The invoked application can thereafter be directed via a keystroke or a simulated keystroke on a mapped key or button. Some embodiments of the invention can be implemented based on software loaded on the user's device (e.g., a computer). Certain other embodiments of the invention can be implemented via a client-server model, with a small client software footprint on the user's device (i.e., the client) to ensure negligible performance impact on the device while operational.

The techniques of the invention have wide applicability in the areas of Internet and corporate intranet content and resource management, and on existing and future computing and wireless platforms including, for example, palm-sized, handheld, mobile, and WAP devices, desktop machines, Web TV consoles, game consoles (e.g. Playstation 2), and other network-capable appliances. An aspect of the invention provides convenience for an end user via an interface whose simplicity hides a set of powerful techniques and capabilities that may be embodied in a distributed server.

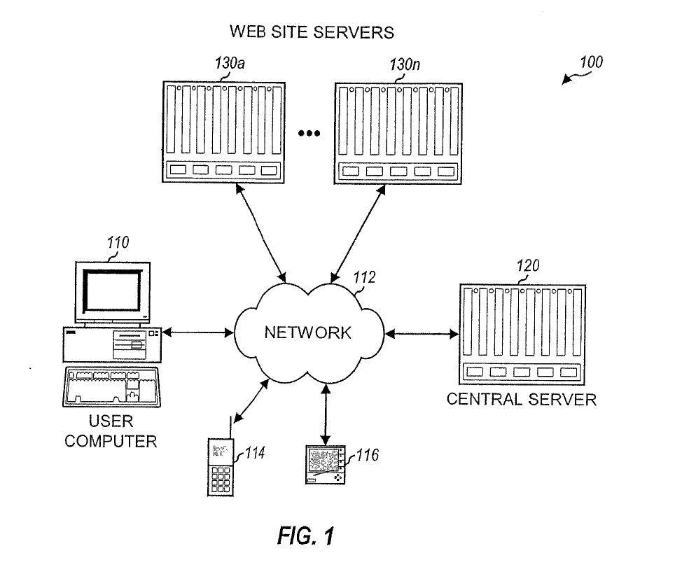

FIG. 1 is a block diagram of a system 100 that can implement various aspects of the invention. System 100 includes a user computer 110 (which may be a desktop PC or a notebook PC) coupled to a network 112 that further couples to a central server 120 and a number of multimedia and Web content servers 130a through 130n. Network 112 may be a local area network (LAN), a wide area network (WAN), a campus network, the World Wide Web (i.e., the Internet), or any other network.

Many aspects of the invention may also be implemented in a wireless cellular phone 114, a personal digital assistant (PDA) 116, or any number of other devices that may also couple to network 112. For clarity, the invention is described in the context of user computer 110.

User computer 110 executes a client software that implement various aspects of the invention, such as allowing a user to access certain pre-defined URLs via associated mapped keys, as described in further detail below. In certain other aspects of the invention, the mapped keys direct an application on user computer 110 to certain multimedia resources on central server 120. Central server 120 may collect certain information related to the resource requests from user computer 110, and may further direct the application to the pre-defined resources available on servers 130. Certain aspects of the invention can be implemented by software codes executing on user computer 110 alone, and certain other aspects of the invention are implemented by software codes executing on both user computer 110 and central server 120, as described in further detail below.

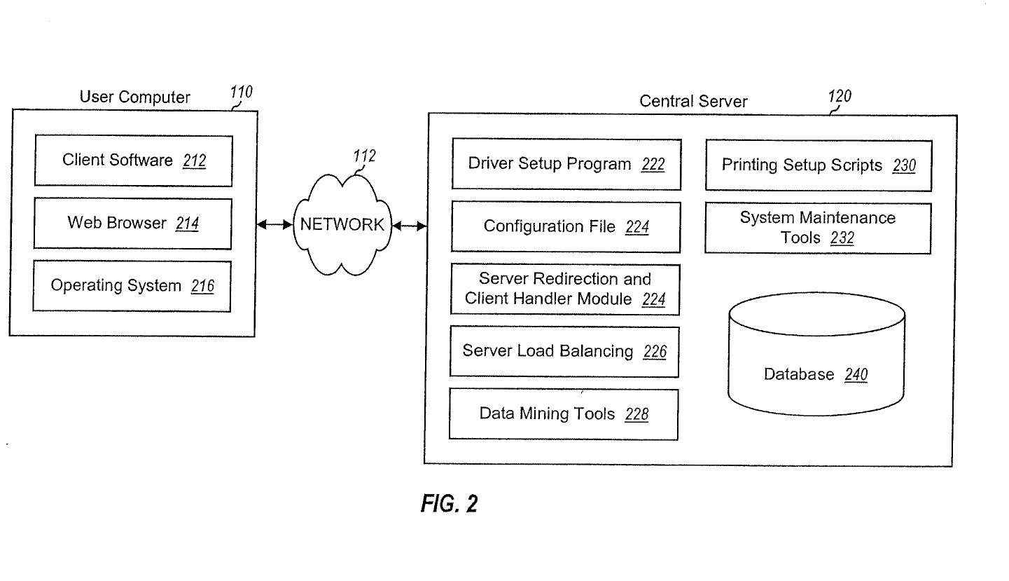

FIG. 2 is a block diagram of user computer 110 and central server 120 in accordance with a specific embodiment of the invention. Various aspects of the invention can be implement with a set of platform independent software component modules. In the embodiment shown in FIG. 2, the module on user computer 110 comprises a client software 212 installed and executing in the background of the user computer and on top of an operating system 216. An application 214 also executes on user computer 110 to allow the user to access various multimedia resources from network 112.

In the embodiment shown in FIG. 2, the components on central server 120 comprise a driver setup program 222, a configuration file 224, a server redirection and client handler module 226, a server load balancing module 228, data mining tools 228, printing setup scripts 230, and system maintenance tools 232. Central server 120 further includes a database 240 used to store information from users and other data. Modules 222 through 232 may be installed or stored on one or more servers. Also, different and/or additional modules may also be provided and are within the scope of the invention.

The functions performed by some of the modules in user computer 110 and central server 120 are described in further detail below.

An aspect of the invention provides techniques to allow a user to map a set of keys on the user computer (or other devices) to an associated set of multimedia resources. On a user computer system, these mapped keys may be the F1 through F12 keys available on most keyboards. Other keys may also be mapped such as, for example, the arrow keys, the Home key, or the numeric keys on the right side of many keyboards, and others. Once the keys are mapped, access to a particular defined multimedia resource, such as an Internet radio or TV station, a locally-stored audio file, or a network-remote video playlist can be quickly and conveniently achieved by a single depression of the key previously defined for that resource. This aspect of the invention may be implemented by client software 212 installed on user computer 110, and interaction with central server 120 is not necessary, except possibly to download the client software.

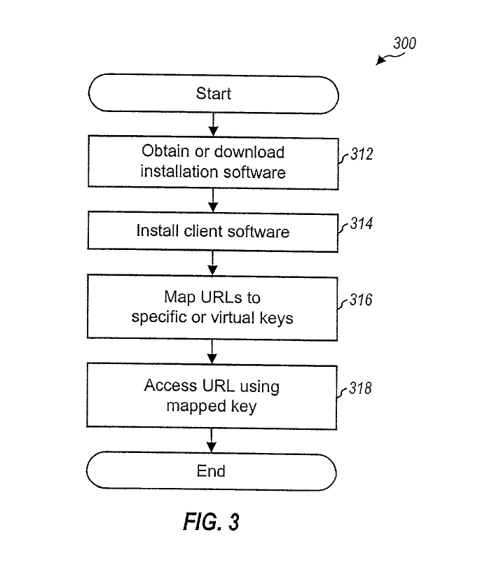

FIG. 3 is a flow diagram of a process 300 for mapping and utilizing “hotkeys” on user computer 110. Hotkeys are a set of keys on the keyboard that have been mapped to specific pre-defined URLs. When enabled, the hotkeys serve to invoke the application associated with the multimedia file linked to that hotkey.

Initially, at step 312, an installation software is obtained from a local device (e.g., a CD-ROM, diskette, or other storage device), by downloading driver setup software 222 from central server 120 via the network onto the local computer, or by some other mechanism. The installation software includes client software 212, which is then installed on user computer 110, at step 314.

In certain embodiments of the invention and as described in further detail below, the user is prompted to complete a short demographic questionnaire during the installation process. As part of the driver installation process, the user is also prompted to associate URLs to a set of specific or virtual keys on user computer 110, at step 316. The keys that may be mapped are dependent on the particular device being installed (e.g., a computer, a cellular phone, a PDA, and so on).

After client software 212 has been installed on user computer 110, the user may thereafter use the mapped keys to navigate the multimedia content. The user can invoke an application for a selected pre-defined URL by pressing on the corresponding mapped key, at step 318, and can thus quickly access the URL via the associated key. The steps in FIG. 3 are described in further detail below.

As shown in FIG. 3, the user initially installs the client software that implements various aspects of the invention. In an embodiment, the client software is packaged with a small text configuration file that specifies some parameters that are used during the installation process. The client software and associated configuration file can be downloaded from central server 120 via the World Wide Web. Alternatively, the client software and configuration file can be obtained via some other media (e.g., a CD-ROM or diskettes).

In an embodiment, both the client software and configuration file are encapsulated together within driver setup program 222 in a single convenient self-extracting executable. This packaged executable may be located on central server 120, as shown in FIG. 2, which also implements certain aspects of the redirection process, as described below. Alternatively, the packaged executable may be located in some other Web server.

The packaged executable can be run in the operating system of user computer 110, once the download completes or the media is provided to the proper storage device (e.g., CD-ROM drive). The executable then causes the setup program to execute. In an embodiment, the setup program first writes a keyboard client (i.e. the client software 212) and the configuration file to a temporary location in a directory on a hard drive of user computer 110. The setup program then moves copies of the keyboard driver and configuration file to a permanent directory location selected by the user or to a default location (e.g., a particular subdirectory under drive C). The setup program then adds a shortcut to the keyboard driver in the user computer's startup area, which ensures that the keyboard driver is started whenever the user computer is restarted. Finally, the setup program invokes the client software 212, which further aids in the installation process.

On first execution of the client software 212 a special (“installation”) mode is used that guides the user through the rest of the installation process. The user may be taken through a process to map a set of keys to Websites or URLs. On subsequent executions of the client software, operation is in a “normal” mode that bypasses the installation process.

For certain aspects of the invention, demographic data is collected from the user during the installation process. The collected demographic data can thereafter be used for various purposes, as described in further detail below. In the installation mode, client software 212 first guides the user through a short series of questionnaire menus that ask for specific demographic information. Such information may include, for example, gender, age, location (e.g., city and zip code), profession, race, hobbies, and other preferences. The user is prompted to enter certain or all items of this information for the setup program to complete successfully. Demographic information is collected from the user, and user-specific information (e.g., name, social security number, and so on) can be also, but need not be, collected.

In accordance with an aspect of the invention, client software 212 computes a unique identification code (UIC) for the user based on the obtained information. The UIC may be stored to the local hard drive. For the Windows operating system, the UIC may be stored to the Registry. Thereafter, each time a mapped key is pressed, the stored UIC can be retrieved and sent along with a the request for the multimedia content associated with the pressed key.

In an embodiment, the UIC includes a combination of the collected demographic information about the end user interspersed with a number of pseudo-random characters. The pseudo-random characters essentially remove the possibility of two users obtaining an identical UIC and further make idle decoding of the UIC string extremely difficult. The pseudo-random characters are generated using a pseudo random number generator. In an embodiment, this generator is seeded with the number of milliseconds since midnight on Jan. 1, 1970 UTC, a number obtained from the operating system during the installation process.

Table 1 shows an embodiment of the structure of the UIC. In this embodiment, the UIC comprises a sequence generated by concatenating the following: (1) five random characters, (2) a single digit indicating the sex, (3) six random characters, (4) a single digit indicating the race, (5) eight random characters, (6) two digits indicating the birth year subtracted from 1900, (7) seven random characters, (8) three digits indicating the country, (9) nine random characters, (10) five digits indicating the zip code, and (11) thirty three random characters.

TABLE 1

| | | | | | | | | | | |
|---|---|---|---|---|---|---|---|---|---|---|
| 5 | Sex (1) | 6 | Race (1) | 8 | Birth Year-1900 (2) | 7 | Country (3) | 9 | Zip (5) | 33 |

As a specific example, a 27 year old white male living in Irvine, Calif. may be assigned a UIC of “0TW7E100A9533K98176O459EB27I20000K1CX7PUX908893R 72677EIBFY6EX0856WQFWV1TBQRAV1F5,” where the Sex, Race, Birth Year, Country, and Zip code demographic information are highlighted, and the other characters are generated by the pseudo random number generator. Examining the bold characters, “1” represents the user's sex (male), “3” represents the user's race (white), “59” represents the user's age, “000” represents the user's country (USA), and “08893” the user's Zip code subtracted from 100,000.

In this example, a total of 68 random characters from the set {A . . . Z, and 0 . . . 9} have been used to make up the UIC of length 80 characters. For this implementation, the probability of two UICs containing the same sequence of 68 random characters is 36⁶⁸ (i.e., approximately 1 followed by 105 zeroes), a number that is many orders of magnitude greater than the population of planet Earth. The UIC of length 80 characters is not significant. However, the UIC length should be significantly larger than the number of characters used to store the demographic information. Greater or fewer number of random characters may also be used for the UIC and are within the scope of the invention.

Based on the above implementation, the possibility of obtaining a duplicate UIC from one invocation of the implementation to the next, is so remote that the user computer (or more specifically, the setup program) can be directed to generate the UIC alone, and there is no need for the installation process to contact the central server to obtain a unique UIC for the user. This feature of the invention is crucial to avoid overload of the server in the case where many installations occur simultaneously. The registration process can thus be completed without a need to communicate with, or receive information from, the central server. This “self-configuration” process makes installation of the client software fast and trouble-free.

### Hotkey Setup Page

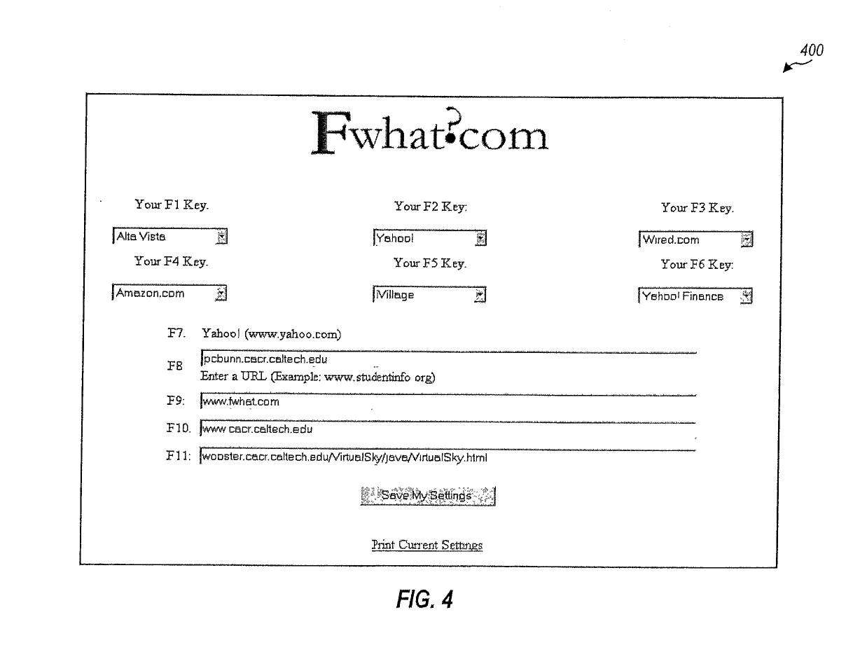

FIG. 4 is a diagram of a hotkey setup page 400 in accordance with an embodiment of the invention. The hotkey setup page allows the user to select the URL to be associated with each of the hotkeys on the keyboard. As noted above, any key on the keyboard may be mapped as a hotkey. In a specific embodiment, the hotkeys are defined using the F1 through F11 keys, and the F12 key is used for another function.

In an embodiment, each hotkey may be individually restricted to either a specific site or a specific set of sites, or may be completely unrestricted. For example, the hotkey setup page may enforce an association of the F1 key with one of the following Web sites: W1, W2, W3, and W4. The F2 key may be restricted to being associated with the Web sites: W2, W3, W6 and W10. The F3 key may be completely unrestricted, allowing the user to enter in a text-based URL.

The manner in which the sites are presented in the hotkey setup page may also change from F key to F key. For example, F5 and F6 may each be associated with the same list of potential Web sites; however, the Web sites for F5 may be listed in a different order than that for F6. The specific Web sites that can be associated with each F key may also be dynamically generated, for example, based on the user's demographic profile. As an example, a 22-year-old female may be provided with Web sites W5, W11, W16, and W21 as options for her F3 key, whereas a 49-year-old male may be provided with Web sites W1, W3, W18, and W33 as options for his F3 key.

The hotkey setup page may be activated at any time by the user to set up or redefine which Web site or URL is to be associated with each hotkey. The hotkey setup page may be accessed using various mechanisms, for example, via a dedicated hotkey, e.g., F12.

### Printable Hotkey Mapping Pages

The central server may generate printable Web pages that serve as “reminder” cards for the user, with each reminder card indicating which hotkeys are associated with which multimedia resources (in this example, Web addresses). This functionality can be offered via a simple link from the hotkey setup page. Alternatively or additionally, the user computer can generate the reminder card via an option on the hotkey setup page. Table 2 lists an example set of hotkeys and their associated Web sites.

TABLE 2

| Hotkey | Web site |
|---|---|
| F1 | Alta Vista |
| F2 | Yahoo! |
| F3 | Wired.com |
| F4 | Amazon.com |
| F5 | iVillage |
| F6 | Yahoo! Finance |
| F7 | Yahoo! |
| F8 | |
| F9 | |
| F10 | |
| F11 | |
| F12 | Key setup hotkey |

### Selection of the Internet Hotkeys

In an embodiment, once the client software is installed on the user computer, it operates in an “active” mode or an “inactive” mode. In the active mode, the mapped keys on the keyboard cease to function in the normal manner. Instead, these keys act as “Internet hotkeys,” i.e., keys whose normal function is suspended and which instead serve to invoke an application on a particular multimedia resource. And in the inactive mode, the mapped keys on the keyboard function in the normal manner and the client software is effectively disabled.

In an embodiment, the client software can be made active or inactive at any time. In one implementation, a “toggle” key can be defined to toggle the client software between the active or inactive state. With a single press on the toggle key, the user can quickly and effectively enable or disable the hotkeys.

The toggle key may be implemented with any specific key on the keyboard. For example, the toggle key may be implemented with one of a number of toggle keys found on the vast majority of standard keyboards such as, for example, the “Scroll Lock”, “Num Lock”, “Pause/Break” keys. However, other keys can also be defined to be the toggle key. The choice of which key to use to toggle the driver operating state can be offered at driver installation time and may also be offered via a runtime configuration option.

In an embodiment, a visual mechanism is provided to indicate to the user whether the hotkeys are active or inactive. This visual mechanism aids the user to identify the current operation state of the client software and to properly use the hotkeys. The visual mechanism is especially useful for keyboards not equipped with an LED indicator on the selected toggle key. In a specific implementation in which the client software is implemented for the Windows operating system from Microsoft Corporation, a color-changing icon in the system tray can indicate whether or not the hotkeys are enabled.

### Use of the Internet Hotkeys

If the hotkeys are enabled (i.e., the toggle key places the client software in the active state), the client software intercepts key presses of any hotkey. As a result, other active applications in the operating system do not detect these key presses.

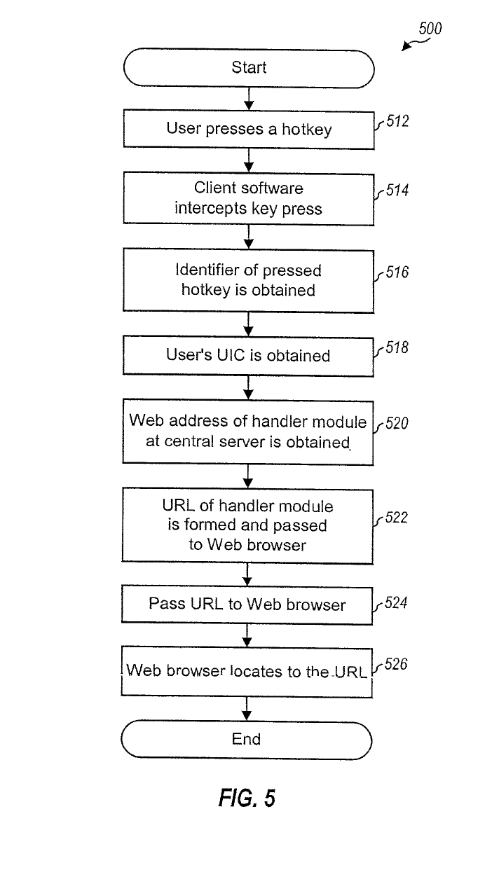

FIG. 5 is a flow diagram of a process 500 for handling a key press of a hotkey in accordance with an embodiment of the invention. Process 500 is performed at the user computer. Initially, a user presses a hotkey, at step 512. The client software intercepts the key press, at step 514, and prevents the key press from propagating to other active applications in the operating system. The client software then obtains the identifier of the pressed hotkey, at step 516.

For certain aspects of the invention, the user's demographic information is collected by the central server with each hotkey press. This information can be used for various purposes as described in further detail below. The following description is for an embodiment in which the user's demographic information is collected as a result of the hotkey press.

At step 518, the user's UIC is obtained, for example, from a local disk configuration file. In a specific implementation for Microsoft Windows, the UIC is retrieved from the System Registry, which is provided with and stores the UIC at the time of the driver installation. The Web address of the central server's handler module (e.g., module 224 in FIG. 2) is also obtained from the configuration file, at step 520. The handler module is typically a script on the same Web server from which the client software was downloaded (e.g., the central server). A URL is then formed which consists of the Web address of the central server's handler module together with the user's UIC and the identifier of the hotkey as parameters, at step 522. The URL is passed as an argument to a Web browser, at step 524. This Web browser can be the user's default browser, which may be Internet Explorer, Netscape Navigator, Opera, or some other Web browser.

The client software thereafter “hibernates” until the next hotkey press, or until the toggle key is pressed to deactivate the driver. In an embodiment, even when deactivated, the client software is able to detect toggle key presses. The client software is thus able to reactivate itself when the user toggles it from the inactive state to the active state.

At step 526, the application running on the user computer starts to process the constructed multimedia resource. If a suitable application is not running,, the default application for that multimedia file type is executed and locates to the resource. If no resource is associated with the pressed hotkey, then the default Web browser can be invoked to the hotkey configuration Web page, or another configuration application can be started.

### Server Side—Key Processing and Load Balancing

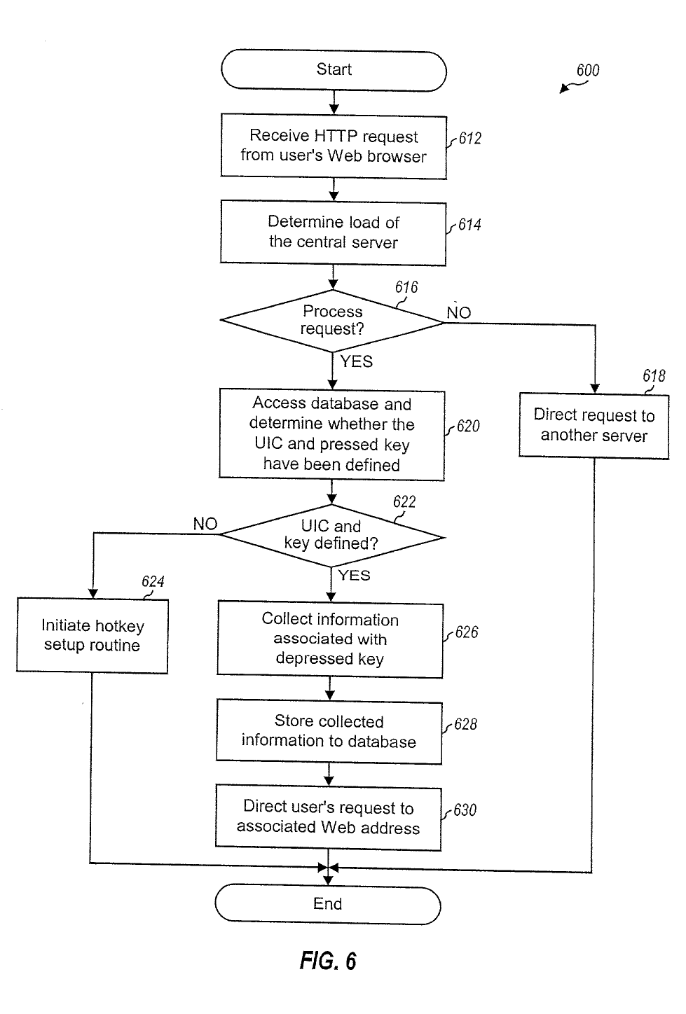

FIG. 6 is a flow diagram of a process 600 for handling an HTTP request generated in response to a hotkey press in accordance with an embodiment of the invention. Process 600 can be performed at the central server. Initially, a Web server assigned to process hotkey presses (e.g., the central server) receives the HTTP request from the user's Web browser, at step 612. The request includes the URL that was constructed by the client software. The central server then determines its load, at step 614.

In an embodiment, a load transfer and balancing mechanism employ to ensure that the servers available to process hotkey presses are evenly loaded. The load transfer and balancing mechanism can be activated when the central server reaches a particular (pre-set) utilization level. Above this level, the central server can act as a load balancer for a set of N other servers. While operating in this capacity, the central server redirects the HTTP request to a particular server “X”, which is selected to evenly balance the load. The selection can be based on various schemes.

In one specific scheme, the selection X is based on two numeric characters, C1 and C2, selected from the UIC provided by the user computer, as follows:

$$X = ⌊ \frac{10 \cdot C1 + C2}{100 / N} ⌋ + 1 , \qquad Eq ( 1 )$$

where and “└ ┘” is a floor operator (i.e., └Y┘ is the greatest integer less than or equal to the real number Y). In this example, C1 and C2 lie between zero and nine. An adjustment of equation (1) is necessary if C1 and C2 are also allowed to take values A through Z. For example, with five servers numbered 1 through 5 available to process hotkey presses, codes 0 to 19 redirect the processing to server 1, codes 20 to 39 redirect the processing to server 2, and so on, and codes 80 to 99 redirect the processing to server 5. This scheme can automatically create a scalable load-balanced system, given a sufficient number of available servers. As more traffic needs to be processed, more servers can be added seamlessly. And as more servers are added to the system, the scheme ensures that an approximately equal amount of work is distributed to each server. This even distribution results from the random nature of the two specific characters, C1 and C2, in the UIC.

Based on the above computation in equation (1), a determination is made whether to process the request or to transfer the processing of the request to another server, at step 616. If the request is to be redirected to another server, that redirection is performed at step 618 and the process terminates. (Or more specifically, the server being transferred the request performs the steps described below).

Otherwise, if the HTTP request is not transferred to another server, it is passed to a key handler module (i.e., module 224 in FIG. 2). The key handler module first opens a connection to a database of UICs and attempts to retrieve the key settings for the received UIC. The database may be implemented using a standard off-the-shelf or custom product capable of sustaining high Transactions Per Second (TPS) on a small number of potentially large tables. Currently available examples of such database products are SQLServer from Microsoft Corporation, Oracle, mySQL, Sybase, Informix, DB2, and so on. In fact, given sufficiently capable I/O devices, a standard random access flat file perhaps hosted in a fast RAM disk may be used to implement the database.

At step 622, a determination is then made whether the UIC and pressed key have been defined. If the UIC is not found in the database, or if no hotkeys have yet been set up by the user, then the server responds to the user's Web browser by redirecting it to a hotkey setup page, at step 624. Otherwise, if the user's UIC is in the database, and if there is a multimedia resource associated with the hotkey, then the server collects information associated with the depressed key, at step 626, and stores the collected information to a database, at step 628. The data to be collected and stored are described in further detail below.

The server then responds to the user's Web browser by directing it to that Web address, at step 630. In some embodiments, the Web browser is redirected to a Web page or other multimedia resource determined by referring to the user's demographic data, which is also stored in the database.

For the above embodiments, the key mapping is performed at the user computer and the key mapping is only known by the server. The client software in the user computer sends the server a message containing the UIC, and the number of the key pressed. The server then determines whether, for this UIC (user), it knows which URL to send the browser to for the pressed key. If the server has such a mapping, then the server sends a message back to the user's browser indicating to which URL the browser should go. If there is no such mapping, the server responds by directing the user to the URL for setting up the keys.

As an example, user A has installed the client software and has defined the F3 key to be associated with the web site “Amazon.com”. When user A presses the F3 key, the client software launches a Web browser (if necessary) and then redirects it to a Web page on the central server. The HTTP request further passes two parameters, the UIC associated with user A and a code identifying which hotkey was pressed. The central server then checks to see that UIC exists in the database and, if so, what URL or Web site has been associated with the F3 key for that UIC.

Since the central server finds that a web site, Amazon.com, has been associated with the received UIC and F3 key, the server determines which specific URL within the Amazon.com web site to redirect the Web browser. This determination can be based on the demographic data embedded within this specific UIC. For example, if user A is a 40 year old male in Washington, D.C., he may be redirected to an Amazon.com web page featuring books about filing Provisional Patent Applications. The server may also simply direct the Web browser to the Amazon.com home page.

The user thus goes to the Web site that he selects. In certain well-defined cases, the browser will be directed to a more appropriate sub-URL, as described below.

### Target Platforms

Referring back to FIG. 2, the set of software modules used to implement various aspects of the invention can be designed to work in various operating systems. In fact, the software modules may be “ported” from one operating system environment to another. The client software has been implemented and tested for the Microsoft Windows family of operating systems, including Windows 95, 98, NT, 2000, XP and Millennium Edition. Other client platforms that may be targeted by the client software include, but are not limited to, Linux, MacOS, Solaris, AIX, HP/UX, WAP devices, Windows CE devices, Palm OS, and other web-enabled operating systems currently in existence and potentially others to be available in the future.

The server side modules have been implemented using Microsoft Windows NT and 2000 Server, Microsoft IIS, Microsoft SQL Server, Active Server Pages and Cold Fusion. Other server platforms that may be targeted include combinations of Linux, Solaris, AIX, HP/UX, with Apache Web Server, MySQL, Oracle, Sybase, Informix, and DB2 (in fact any SQL-compliant database), with appropriate compiled or scripting languages to interface between the Web server and database on each platform.

### Applications of the Hotkeys Technology

The software modules described herein can operate in a straightforward fashion in conjunction with a common “101-key” US keyboard. However, the component-based nature of the system architecture allows each piece of the system to be replaced using a different technology. The techniques of the invention may also be applied to other innovative applications, as described briefly below.

Virtual function keys—screen-based icons that act as though they are function keys, replacing physical function keys. The full functionality of the invention described herein can be applied to virtual function keys, whether they are screen based on a personal computer, palm-pilot, PDA, or other wireless device.

For wireless Internet applications—the client software on the wireless device can pass a parameter to the central server to tell the type of device being used. The central server can then route the user to the appropriate web page or invoke the appropriate application using the client software as a proxy. For example, a user on a wireless web telephone can be routed to Yahoo's wireless phone web page, instead of Yahoo's general web page (which may be designed for personal computers).

The hotkey software may be integrated to other hardware devices such as keyboard hotkeys, devices for the physically impaired and other input mechanisms.

The paradigrn of using shortcuts while working at a computer is a powerful convenience to the user. Being able to branch to a new Web location or different multimedia file with a single key press, a single tap of a stylus, a nod in a particular direction whilst immersed in a virtual environment, by pointing a finger while wearing a haptic glove, or perhaps by whistling a note are just examples of existing and future possibilities. The techniques of the invention may also be adopted for use by the disabled or by people working in hostile environments. The hotkey techniques described herein are enabling technology in this field.

### Data Mining

Besides being a significant convenience for the end user, the central server can make use of software designed to analyze the collected user key data to provide valuable “key through” statistics. These statistics may further be coupled with demographic data, time of day information, and possibly other data. The information collected and available at the central server may have enormous sociological and/or commercial value to parties wishing to understand how a user community is using the Internet Web, a corporate or private intranet Web, or which multimedia content is being accessed when, how often, and by which classes of client users. Data mining of the hotkey data may reveal useful and perhaps unexpected correlations.

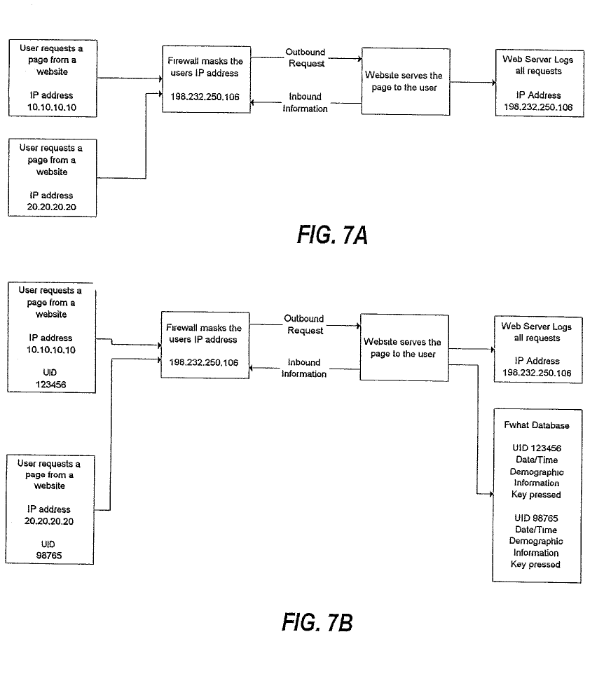

FIG. 7A is a diagram that illustrates a conventional Web site logging technique. Typically, a corporation masks the Internet addresses of their internal users to a single IP address. For the example shown in FIG. 7A, the user IP addresses 10.10.10.10 and 20.20.20.20 are mapped to the single IP address 198.232.250.106. This mapping to a unity IP address makes it impossible for a Web server to obtain individual information for the users since all of their requests seemingly come from the same IP address.

FIG. 7B is a diagram that illustrates a Web site logging technique in accordance with an aspect of the invention. As noted above, individual information can be provided to the central server via the UIC. The UICs for users can be stored on the central server. Since the individual information is stored on the central server and not on the user's local computer, this information can be accessed from the central server at any time.

Various types of information can be collected and stored at the central server. In an embodiment, a time stamp of each hotkey press is stored in the database along with other information on the pressed key. Specific information about every user's Web site or other multimedia resource selections, along with information about every hotkey that was pressed and the time and date of each keystroke can be logged in the database. This information can be tied directly to a user's UID. Thus, demographic data is directly and readily available from the database.

Sophisticated trend analysis and predictions can thereafter be performed, for example, on an hour-by-hour, minute-by-minute basis, and so on. As more and more users are amassed, the system acquires valuable real-time proprietary information that can be stored into the database.

The collected information can be used for various purposes. For example, the information can be used to determine how often specific content is selected by various demographic subgroups, how many multimedia resources from one company have been defined alongside resources from competitors, how utilization of the multimedia resources varies with time, and so on. A data structure of this information may be published and may further be integrated with external data mining tools (e.g., Crystal Reports, Webtrends, and others) to produce reports. The information collected using the techniques of the invention may be especially useful for corporate websites that have a large number of corporate users.

### Hotkey Lists

In an implementation, the users pay nothing to download the software and acquire the hotkey functionality. Web companies and advertisers (collectively, “Web entities”) typically find it very helpful or commercially advantageous to be listed in the set of pre-selected multimedia resources that can be mapped to specific hotkeys.

Various economic models can be used in the deployment of the hotkey feature of the invention. In one scheme, the Web entities can be charged a first set of fees for inclusion in these lists, for priority placement in these lists (e.g., the top of a list, as oppose to the bottom of the list), for exclusion of competitors in these lists, and for other things.

In another scheme, the Web entities may be charged a second set of fees for redirecting users' multimedia applications to their content. The central server can further pass parameters that identify the users (i.e., the customers) when they arrive at a target resource. This scheme can be used to implement a pay-for-performance, verifiable system for Internet marketing.

As an example, Yahoo! may be charged a first amount (e.g., $15,000) to be the first search engine in the drop-down list of Web sites that can be associated with the F4 key. Yahoo! may further be charged a second smaller amount (e.g., $0.02) for each user who is redirected to Yahoo's Web site. The central server can pass a special code to the Yahoo server each time a user is redirected by the central server to Yahoo!. This special code may include the users demographic data (e.g., race, sex, age, location, and so on) along with encoded competitive intelligence data (e.g., data showing what other Web sites this user has selected to associate with his other function keys). The demographic data and intelligence data may be continually updated such that it is current.

### Advertising Methods

An ultimate business-oriented goal is to ensure that the users find the hotkey feature convenient and easy enough to use on a regular basis. Various schemes can be used to assist the users in determining which multimedia resources correspond to which hotkeys. These assistance tools can be free and simple for users to access quickly, which can then ensure that the hotkeys are used regularly.

In one scheme, the users can request and are provided with a transparent type of label that has the hotkey directory printed on it. For this scheme, control of the advertisers/partners that may get special placement or even a color logo on the labels sent can be controlled. From a marketing perspective, this creates an additional benefit that can be offered to potential strategic partners and/or advertisers. This also adds a branding dimension to the business model that may increase potential revenue from the advertisers and can be an additional revenue stream, by charging advertisers to place stuffers inside of the envelopes used to send the labels.

In another scheme, the users are provided with a customized hotkey mouse pad that includes the hotkey directory. Various other assistance tools can also be contemplated and are within the scope of the invention.

### Specific Implementation

A specific implementation of the techniques described herein is described in the attached Exhibit A.

### Computer System

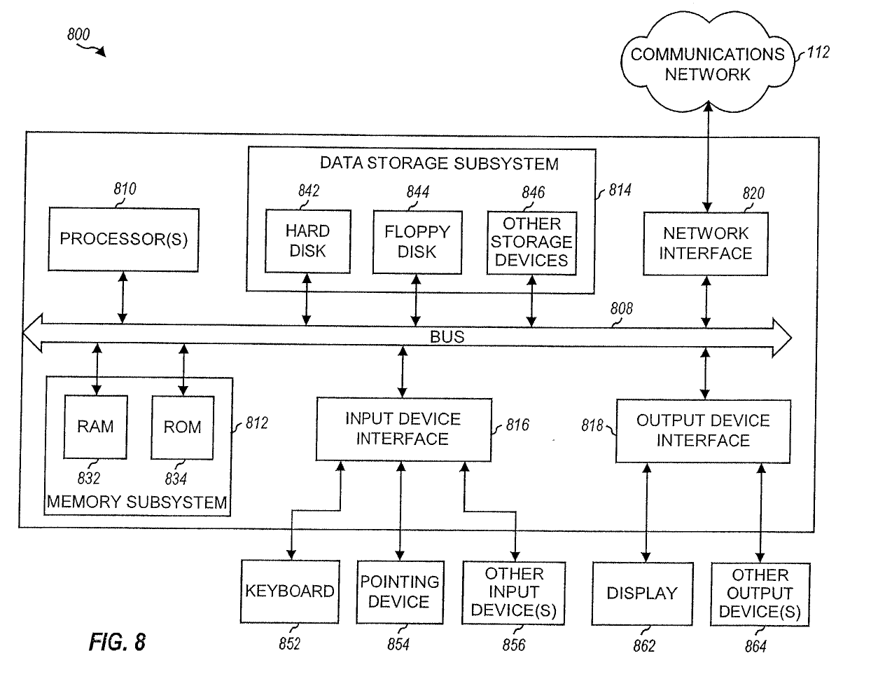

FIG. 8 is a block diagram of an embodiment of a computer system 800 that can be used to implement user computer 110 or central computer 120 in FIG. 1. As shown in FIG. 8, computer system 800 includes a bus 808 that interconnects major subsystems such as one or more processors 810, a memory system 812, a data storage subsystem 814, an input device interface 816, an output device interface 818, and a network interface 820.

Bus 808 provides a mechanism for allowing various components and subsystems of computer system 800 to communicate with each other. Many of the subsystems and components of computer system 800 need not be at the same physical location but may be distributed at various locations throughout the communications network. Although bus 808 is shown in FIG. 8 as a single bus, alternate embodiments of bus 808 may utilize multiple busses.

Processor(s) 810 perform many of the processing functions for computer system 800 and communicate with a number of peripheral devices via bus 808. Memory subsystem 812 and data storage subsystem 814 store the programming and data constructs that provide the functionality of computer system 800. For example, the schedules and modules implementing the functionality of the invention may be stored in data storage subsystem 814. These schedules and modules are then provided to memory subsystem 812 and the modules are executed by processor(s) 810. In a distributed environment, the modules may be stored on a number of computer systems and executed by the processors of these computer systems.

Memory subsystem 812 typically includes a number of memories including a random access memory (RAM) 832 and a read only memory (ROM) 834. RAM 832 is typically used to store instructions and data during program execution and ROM 834 is typically used to store fixed instructions and data.

Data storage subsystem 814 provides persistent (non-volatile) storage for schedules and modules, and may include a hard disk drive 842, a floppy disk drive 844, and other storage devices 846 such as a compact digital read only memory (CD-ROM) drive, an optical drive, and removable media cartridges. Each of the storage devices may be associated with removable media (e.g., floppy disks, CD-ROMs, and so on). One or more of the storage devices may be located at remote locations and coupled to computer system 800 via communications network 112.

Input device interface 816 provides interface with various input devices such as a keyboard 852, a pointing device 854 (e.g., a mouse, a trackball, a touch pad, a graphics tablet, a scanner, or a touch screen incorporated into a display), and other input device(s) 856. In general, the term “input device” is intended to include all possible types of devices and ways to input information into computer system 800. Via the input devices, the user is able to browse the Web, select a particular web page, select a particular region of the selected web page, schedule the transmission of information, and perform other functions.

Output device interface 818 provides an interface with various output devices such as a display 862 and other output device(s) 864. Display 862 may be a cathode ray tube (CRT), a flat-panel device such as a liquid crystal display (LCD), a projection device, and other visual devices. In general, the term “output device” is intended to include all possible types of devices and ways to output information from computer system 800 to a human or to another machine or computer systems. Via the output devices, the user is shown the selected information, possible scheduling options, and other information.

Network interface 820 provides an interface with outside networks including communications network 112 (e.g., the Internet). Through network interface 820, computer system 800 is able to communicate with other computer systems coupled to communications network 112, which may be coupled to the cellular service providers. Network interface 820 can provide a wireline or wireless interface to communications network 112.

Many other devices or subsystems (not shown) can be coupled to computer system 800. In addition, it is not necessary for all of the devices shown in FIG. 8 to be present to practice the invention. Furthermore, the devices and subsystems may be interconnected in configurations different from that shown in FIG. 8. The operation of a computer system such as that shown in FIG. 8 is readily known in the art and not described in detail herein. The source code to implement some embodiments of the invention may be operatively disposed in memory subsystem 812 or stored on storage media such as a hard disk, a floppy disk, or a CD-ROM that is operative with a CD-ROM player.

Headings are included herein for reference and to aid in locating certain sections. These headings are not intended to limit the scope of the concepts described therein under, and these concepts may have applicability in other sections throughout the entire specification.

The foregoing description of the specific embodiments is provided to enable any person skilled in the art to make or use the present invention. Various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein, and as defined by the following claims.

### EXHIBIT A

Provide a simple and organized platform for consumers to access digital resources, while empowering businesses to understand their consumers and deliver a customized user experience.

### System Overview

The iFunction technology is a flexible and robust tool that gives your users a single, instant point of access to your online resources. The product consists of five primary components:

1) The iFunction Download—is a thin client, (80k) that sits on the user's hard drive and optimizes their pc to dynamically launch via end users function keys: websites, music files, music players, play lists, and streaming audio. The users up/down left/right arrows control multimedia selection and volume functions.

2) IFunction Toolbar—is the users control panel which displays which keys are associated to the respective commands. It also provides various components to help facilitate the user's web experience.

3) IFunction messenger—This allows the administrators of the technology to communicate with their user base. They can send out messages communicating special promotions, concerts, polls, and events for demographically specific groups of users. Through the messenger we can also stream content respective to the consumers tastes (ie. financial news, world news, entertainment and sports related news). They can even implement a ticker symbol that could stream stock quotes.

4) IFunction User Page—This is the user's personalized page that allows them to edit their function keys, create their own customized directory of the resources that they access most often. It also serves as a bulletin board for the company's administrator to post messages, latest hits, links to new artists and way for to hold conduct market research surveys.

5) IFunction Manager—This is the administrators central control panel to the entire base of ifunction users. It gives you total control over every aspect of the user's experience, while delivering real time critical, real time user data.

### Features

The iFunction technology provides a unique value proposition for the music industry to innovate in the distribution of digital music. Those value propositions can be best described by the three ways in which it empowers the industry to service its consumers.

1. Service the User:

I. Provide your listeners with the most convenient and simple method to access to an organized selection of their favorite music, through a single click or key stroke.

II. Listeners' keyboard is transformed in to a music “play board” Function keys (F1-F12), act as dynamic hot keys that launch selections while arrows control tracks and volume. Let them really “press play”.

III. Listeners' desktop toolbar serves as a visual mnemonic and access method of their audio settings. Since it is external to the browser, it is a persistent desktop feature for easy access, not limited to browser functions.

IV. User Page provides a simple, easy to use interface which allows listeners to create, personalize and updates settings instantly.

V. Messenger precisely distributes timely and useful and welcomed communication to listeners.

VI. Instantly update client configurations to respond quickly to changing needs and evolving goals.

2. Understand the User: using the iFunction Manager (data mining)

I. Collect and aggregates listeners' demographic data.

II. Organize your users into relevant demographic groups.

III. Gain insight and understanding into your listeners' behavior to create a personalized experience.

IV. Obtain valuable and useful market research in real time.

V. Survey listeners about new music and artists.

VI. Learn which services of music selections have greatest demand within respective demographic groups.

VII. monitor and optimize usage service

VIII. Identify and correct bottlenecks and inefficiencies.

3. Market to the User:

I. Communicate with specific audiences to distribute timely and accurate information and messages to the right audiences, via User Page and Messenger

II. Utilize the information to promote and sell products demanded by users.

III. Implement effective, targeted marketing and advertising campaigns.

IV. Provide new selections to users based on data-mining.

V. Offer new music compilations as teasers and marketing tools.

VI. Integrated desktop toolbar provides consistent branding while your users are both on and offline

[image]

[image]

What is claimed is:

1. A method for invoking an application to process a multimedia resource specified by a Uniform Resource Locator (URL), the method comprising:
mapping a set of keys on a user device to a set of URLs;
detecting activation of a particular mapped key;
retrieving a URL associated with the activated mapped key; and
invoking an application to process the media resource specified by the retrieved URL.

2. The method of claim 1, wherein the retrieved URL is a resource on a server designated to process requests generated in response to activation of any one of the mapped keys.

3. The method of claim 1, further comprising:
accessing a particular Web page having a link for a setup program;
downloading the setup program onto the user device; and
executing the setup program to assist with the mapping of the set of keys.

4. The method of claim 1, further comprising:
obtaining demographic data for a user of the user device.

5. The method of claim 4, further comprising:
generating a unique identification code for the user.

6. The method of claim 5, wherein the unique identification code is generated based on the supplied demographic data for the user.

7. The method of claim 6, wherein the unique identification code is further generated based on a pseudo-random number.

8. The method of claim 5, wherein the directing the Web page includes generating an application invocation request, using the HTTP protocol, for the activated mapped key, wherein the request includes the URL associated with the activated mapped key and the unique identification code.

9. The method of claim 8, further comprising:
sending the HTTP request to a server designated by the URL

10. The method of claim 8, further comprising:
processing the request local to the client system.

11. The method of claim 8, wherein the HTTP request further includes an identifier for the activated mapped key.

12. The method of claim 1, further comprising:
receiving a first indication to disable the set of mapped keys; and
disabling the set of mapped keys in response to the received first indication.

13. The method of claim 12, further comprising:
receiving a second indication to enable the set of mapped keys; and
enabling the set of mapped keys in response to the received second indication.

14. The method of claim 1, wherein the set of mapped keys are selected from a set of functional (F) keys available on a computer keyboard.

15. A method for mapping a set of keys on a user device to a set of Uniform Resource Locators (URLs), the method comprising:
associating each key in a first set of keys with a respective set of one or more URLs; and
for each of one or more keys in the first set,
receiving a selection for a particular URL in the associated set of URLs, and
mapping the key to the selected URL.

16. The method of claim 15, further comprising:
associating each key in a second set of one or more keys with a respective URL.

17. The method of claim 15, further comprising:
associating each key in a third set of one or more keys with an unrestricted URL; and
for each of one or more keys in the third set,
receiving an entry for a particular URL, and
mapping the key to the entered URL.

18. The method of claim 15, further comprising:
storing the URL for each mapped key to a storage unit.

19. A method for processing HTTP requests at a first server, the method comprising:
receiving an HTTP request from a user device, wherein the request includes a unique identification code and an identifier for a particular key activated to generate the request;
determining a multimedia resource location for the activated key; and
directing the received request to the determined resource address for the activated key.

20. The method of claim 19, wherein the resource address for the activated key is determined based on the unique identification code and the identity of the activated key.

21. The method of claim 19, wherein the resource address for the activated key is retrieved from a database used to store resource addresses for unique identification codes and keys.

22. The method of claim 19, further comprising:
collecting demographic information associated with the received request.

23. The method of claim 22, wherein the demographic information is encapsulated within the unique identification code.

24. The method of claim 22, further comprising:
collecting descriptive information associated with the received request.

25. The method of claim 24, wherein the descriptive information includes a particular time of day the request was received.

26. The method of claim 19, further comprising:
initiating a setup program if the unique identification code or identity of the activated key is unrecognized.

27. The method of claim 19, further comprising:
determining a load at the first server; and
directing the received request to a second server if the load at the server is above a particular threshold.

28. The method of claim 19, further comprising:
identifying the number of servers available to process requests;
computing a code for the received request; and
directing the received request to one of the available servers based on the computed code.

29. The method of claim 28, wherein the computed code is based on at least a portion of the unique identification code included in the received request.

30. A computer program product for directing an application to a Uniform Resource Locator (URL), comprising:
code that maps a set of keys on a user device to a set of URLs;
code that detects activation of a particular mapped key;
code that retrieves a URL associated with the activated mapped key;
code that directs the application to the retrieved URL, wherein the application is a Web browser or a multimedia player; and
a data storage medium operative to store the codes.

31. A server operative to process HTTP requests and comprising:
a data storage medium configured to store a handler module operable to
receive a request from a user device, wherein the request includes a unique identification code and an identifier for a particular key activated to generate the request,
determine a multimedia resource address for the activated key, and
direct the received request to the determined resource address for the activated key; and
at least one processor operatively coupled to the data storage medium and configured to execute the one or more modules stored therein.

32. The computer program of claim 31, wherein the data storage medium is further configured to store a data mining module operable to
collect demographic information associated with the received request,
collect information relating to a particular time of day the request was received, and
collect an identity of the particular key activated to generate the received request.

33. The computer program of claim 31, wherein the data storage medium is further configured to store a load balancing module operable to
identify the number of servers available to process requests,
compute a code for the received request, and
direct the received request to one of the available servers based on the computed code.
